(19) United States
(12) Patent Application Publication
(10) Pub. No.: US 2012/0324743 A1
(43) Pub. Date: Dec. 27, 2012

(54) Battery Driven Electric Tool

(75) Inventors: Oskar Bergquist, Huskvarna (SE); Johan Björnlinger, Huskvarna (SE); Pär Martinsson, Jonkoping (SE)

(73) Assignee: HUSQVARNA AB, Huskvarna (SE)

(21) Appl. No.: 13/582,285

(22) PCT Filed: Mar. 6, 2010
(86) PCT No.: PCT/EP10/01407

§ 371 Date: Aug. 31, 2012

(51) Int. Cl. B25F 5/02; A01G 3/053; A01D 34/416; B27B 17/00

(52) U.S. Cl. 30/381; 173/170; 30/196; 30/276

(57) ABSTRACT

A balanced electric power tool (100, 700) is provided. The electric power tool (100, 700) may include a tool body (102, 702) and one or more working implements coupled to the tool body (102, 702). Further, the one or more working implemments may be connected to an electric drive motor. The electric power tool (100, 700) further includes at least one battery (114, 712), which may include at least one battery cell (204), for supplying the electric drive motor (110, 710) with electrical energy. The electric power tool (100, 700) further inlcudes a front handle (104, 704) and a rear handle (106, 706). The front handle (104, 704) is located at least partly in front of the rear handle (106, 706) along a longitudinal axis (L, L′) of the electric power tool (100, 700). Further, the overall centre of gravity of the electric power tool (100, 700) is located proximate to the rear handle (106, 706) in a vertical direction

### TECHNICAL FIELD

The present invention relates to an electric power tool. In particular, the present invention relates to an electric power tool which is powered by a battery.

### BACKGROUND

Battery powered hand-held electric power tools, such as, but not limited to, chainsaws, line trimmers, and hedge trimmers are well known in the art. Typically, a battery may be detachably attached to an electric power tool and provides electrical energy to an electric drive motor. Hand-held electric power tools may also include a front handle and a rear handle to grip and manipulate the power tool. The drive motor and the battery may be of significant weight to provide sufficient power and duration for various operations, thereby increasing the overall weight of the electric power tool. The locations of the centre of gravity of the battery and the drive motor in the electric power tool are crucial to provide an operator with ease of handling and good balance during operation despite the increased overall weight.

Typically, the location of the drive motor may be fixed relative to other components whereas the location of the battery may be varied. An improper positioning of the centre of gravity of the battery may result in an imbalance of the electric power tool and increased operator fatigue during operation.

Generally, in the art, the positioning of the battery and the motor results in the front handle to be arranged above the overall centre of gravity of the electric power tool. However, such a location of the overall centre of gravity may not provide sufficient balance of the hedge trimmer during operation.

In light of the foregoing, there is a need for a battery powered hand-held electric power tool that may provide better handling and balance during operation of the electric power tool.

### SUMMARY

In view of the above, it is an objective of the present invention to solve or at least reduce the problems discussed above. In particular, the objective is to provide an improved electric power tool, which is powered by a battery, such that the electric power tool may provide good handling and balance during operation.

The objective is at least partially achieved according to a novel electric power tool described in claim 1. The electric power tool includes a tool body, one or more working implements coupled to the tool body, an electric drive motor drivably connected to the one or more working implements, and at least one battery connected to the electric drive motor for supplying it with electrical energy. The tool body includes a front handle and a rear handle such that the front handle is located at least partly in front of the rear handle along a longitudinal axis. Further, the overall centre of gravity of the electric power tool is located proximate to the rear handle in a vertical direction. In an aspect of the present invention, proximity of the overall centre of gravity to the rear handle in the vertical direction may improve handling and balance of the electric power tool during operation.

According to claim 2, the battery is provided proximate to the rear handle in the vertical direction. The overall centre of gravity of the electric power tool may be located proximate to the drive motor in absence of the battery. Such a location of the centre of gravity of the battery may shift the overall centre of gravity of the electric power tool towards the rear handle in the vertical direction.

According to claim 3, the centre of gravity of the battery is located on a mid-plane of the rear handle in a substantially lateral direction. Further, according to claim 4, the battery contains the mid-plane of the rear handle in the substantially lateral direction. Alternatively, according to claim 5, the battery is located sideways of the mid-plane of the rear handle in the substantially lateral direction. The three alternative configurations of the battery with respect to the mid-plane of the rear handle may result in an improved balancing of the electric power tool in the substantially lateral direction.

According to claim 6, the battery is located at least partly behind the rear handle along the longitudinal axis. Alternatively, according to claim 7, the battery is located at least partly in front of the rear handle along the longitudinal axis.

According to claim 8, wherein the battery is located at least partly behind the electric drive motor along the longitudinal axis.

According to claim 9, the battery is removably attached to the tool body substantially from left.

According to claim 10, the battery is removably attached to the tool body substantially from right.

According to claim 11, the battery is removably attached to the tool body substantially from above.

According to claim 12, the battery is removably attached to the tool body substantially from below.

According to claim 13, the battery is removably attached to the tool body substantially from rear.

According to claim 14, the at least one battery cell is substantially parallel to a motor shaft.

According to claim 15, the electric power tool is one of a chain saw, a hedge trimmer, or a line trimmer.

### BRIEF DESCRIPTION OF THE DRAWINGS

The invention will in the following be described in more detail with reference to the enclosed drawings, wherein:

FIG. 1A illustrates a side view of an electric power tool, according to an embodiment of the present invention;

FIG. 1B illustrates a rear view of the electric power tool, according to an embodiment of the present invention;

FIG. 2 illustrates a rear view of the electric power tool with a battery removably attached to the electric power tool from left, according to an embodiment of the present invention;

FIG. 3 illustrates a rear view of the electric power tool with the battery removably attached to the electric power tool from right, according to an embodiment of the present invention;

FIG. 4 illustrates a side view of the electric power tool with the battery removably attached to the electric power tool from above, according to an embodiment of the present invention;

FIG. 5 illustrates a side view of the electric power tool with the battery removably attached to the electric power tool from below, according to an embodiment of the present invention;

FIG. 6 illustrates a side view of the electric power tool with the battery removably attached to the electric power tool from rear, according to an embodiment of the present invention;

FIG. 7 illustrates a side view of the electric power tool with rear handle configuration, according to another embodiment of the present invention.

### DESCRIPTION OF EMBODIMENTS

The present invention will be described more fully hereinafter with reference to the accompanying drawings, in which example embodiments of the invention incorporating one or more aspects of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, one or more aspects of the present invention can be utilized in other embodiments and even other types of devices. In the drawings, like numbers refer to like elements.

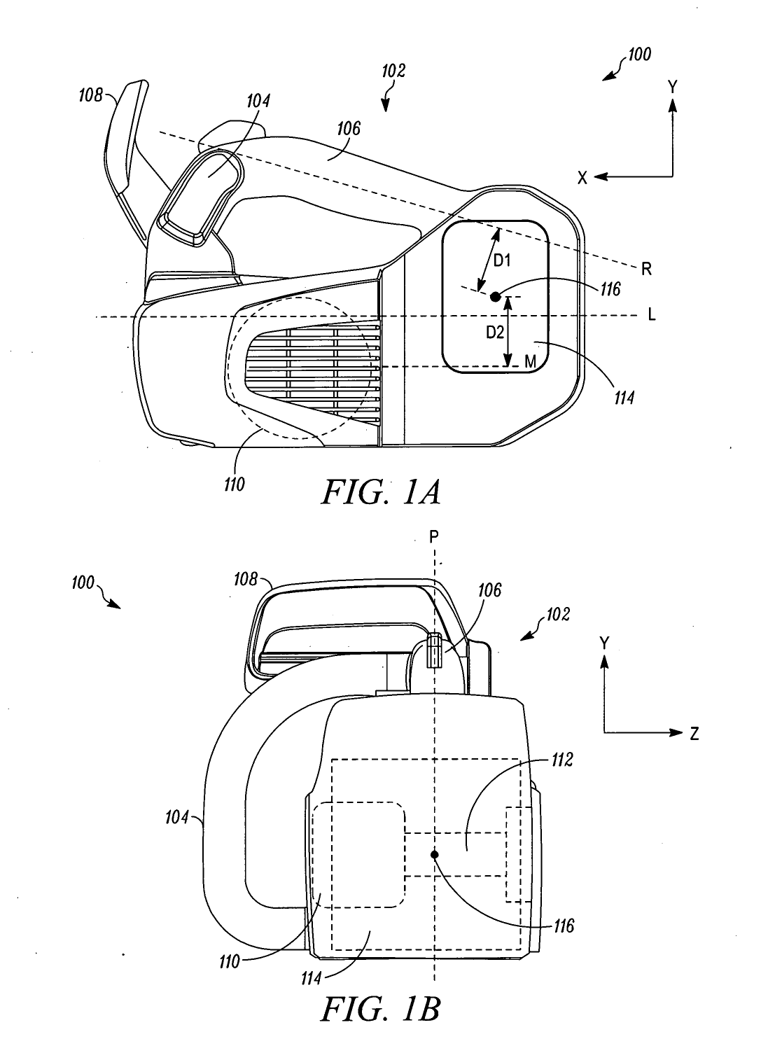

FIGS. 1A and 1B illustrate an example chain saw 100, according to an embodiment of the present invention. The chain saw 100 (hereinafter referred to as the “electric power tool 100”) may be used in gardening or forestry applications. It is apparent to a person who is ordinarily skilled in the art that the present invention may also be used in any other battery powered hand-held equipment with two handles, such as but not limited to, line trimmers, hedge trimmers, rotary saws, or other cutting or pruning tools without departing from the essence of the present invention. In addition, any suitable size, shape or type of elements or materials could be used.

FIGS. 1A and 1B further illustrate a co-ordinate system for the electric power tool 100. An x-axis is substantially parallel to a longitudinal axis L of the electric power tool 100. As shown in FIG. 1A, y-axis is substantially perpendicular the longitudinal axis L of the electric power tool 100.

Further, as used herein, the terms “longitudinal direction”, “lateral direction”, and “vertical direction” indicate a direction relative to the electric power tool 100. The term “longitudinal direction”, without further specificity, is a reference to a direction substantially parallel to the longitudinal axis L, and thus, the x-axis. The terms “vertical direction” and “lateral direction”, without further specificity, are a reference to directions that are substantially parallel to the y-axis and the z-axis respectively. The terms “front” and behind” with respect to a part or portion of the electric power tool 100 may in general refer to sides of the part or portion along the longitudinal direction, “front” being further from a user than “behind” in a working position of the electric power tool 100. The terms “top” and “below” may in general refer to sides of the electric power tool 100 substantially along the y-axis, “top” and “below” being at the top and the bottom respectively in a working position of the electric power tool 100. The terms “left” and “right” may generally refer to left and right sides respectively of the electric power tool 100 along the z-axis from the point of view of the user in the working position of the electric power tool 100. The term “oblique” may refer to any non-orthogonal direction or alignment.

In an embodiment of the present invention, the electric power tool 100 may include a tool body 102 and one or more working implements (not shown) that are coupled to the tool body 102. In an embodiment of the present invention, the working implements may include a toothed chain supported on a guide bar. The guide bar may be attached to tool body 102 via one or more fasteners. Further, a drive sprocket and an idler sprocket may be present at a proximate end and a distal end of the guide bar respectively with respect to the tool body 102.

In an embodiment of the present invention, the tool body 102 may include a front handle 104 and a rear handle 106. In an embodiment of the present invention, the front handle 104 may be located at least partly in front of the rear handle 106 along the longitudinal axis L. In various embodiments of the present invention, at least one of the front handle 104 or the rear handle 106 may include vibration absorbing means, such as but not limited to, springs, rubber members, and the like. Further, the front handle 104 and/or the rear handle 106 may also include ribbed portions (not shown) to enable a better grip for the electric power tool 100. In an embodiment of the present invention, a guard 108 may be present to safeguard the user during a cutting operation. Further, the tool body 102 may also include a cover for safety and smooth functioning of various moving parts.

In an embodiment of the present invention, an electric drive motor 110 may be drivably connected to the drive sprocket. The electric drive motor 110 may include a motor shaft 112 which may be connected to the drive sprocket via suitable transmission means (not shown), such as, but not limited to, one or more gears, belt drive, friction drive, or any combination of these. The transmission means may be utilized to selectively drive the drive sprocket at one or more speeds. The electric drive motor 110 may be an electrically powered motor, such as, but not limiting to, AC motor, DC motor, and the like. In an embodiment of the present invention, the speed and torque of the electric drive motor 110 may be continuously or discretely varied by suitable control means. The control means may include one or more sensors to sense various parameters of the electric drive motor, for example, speed, torque etc. The sensed parameters may then be utilized to control the speed and/or torque of the electric drive motor 110. As shown in FIG. 1B, the electric drive motor 110 may be located on the left side of the tool body 102. However, other alignments of the electric drive motor 110 with respect to the tool body 102 may be possible, without deviating form the scope of the present invention.

In an embodiment of the present invention, at least one battery 114 may be provided in the tool body 102 to selectively supply electrical energy to the electric drive motor 110. In an embodiment of the present invention, the battery 114 may be removably attached to the tool body 102. The rated power and other specifications of the electric drive motor 110 and the battery 114 may be selected based on various parameters, such as, but not limited to, power requirements, operational durations, expected life, cost, weight, dimensions etc.

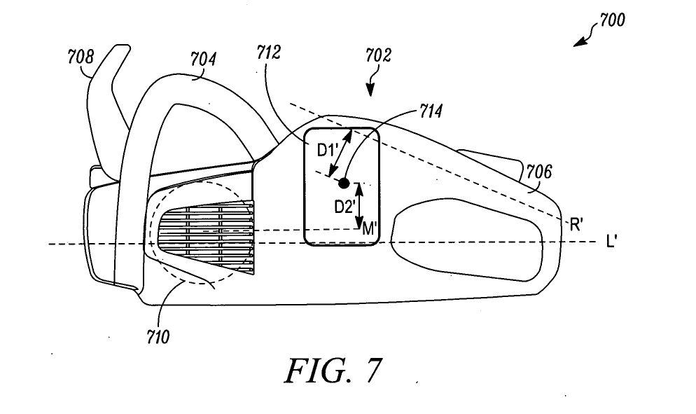

Further, as shown in FIG. 1, the battery 114 may be located at least partly behind the rear handle 106 along the longitudinal axis L. This configuration of the electric power tool 100 may be generally referred to as the “top handle” configuration. Alternative configurations, such as the “rear handle” configuration, wherein the battery 114 may be located at least partly in front of the rear handle 106 (described in detail in conjunction with FIG. 7), are possible without deviating from the scope of the present invention. As shown in FIG. 1, the centre of gravity 116 of the battery 114 may be located at a distance D1 from a rear handle axis R and a distance D2 from an electric drive motor axis M in a substantially vertical direction. The rear handle axis R and the motor axis M may be symmetrically aligned with respect to the rear handle 106 and the electric drive motor 110 respectively in a substantially vertical direction. In an embodiment of the present invention, D1 may be such that the centre of gravity 116 of the battery 114 may be located proximate to the rear handle 106 in a vertical direction. In absence of the battery 114, the overall centre of gravity of the electric power tool 100 may be located proximate to the electric drive motor 110. However, the location of the centre of gravity 116 of the battery 114 discussed in the present invention may shift the overall centre of gravity of the electric power tool 100 towards the rear handle 106 in the vertical direction, which may improve handling and balance of the electric power tool 100 during operation.

In a further embodiment of the present invention, D1 may be minimized by varying various parameters. The various parameters may include, but not limiting to, location of the battery 114 in the tool body 102 with respect to other components (e.g. D2), shape, dimensions, arrangement and/or total weight of the battery 114, location, weight arid/or dimensions of the electric drive motor 110, etc.

Further, as shown in FIG. 1B, the centre of gravity 116 of the battery 114 may be located on a mid-plane P of the rear handle 106 in a substantially lateral direction that is substantially parallel to the z-axis. The mid-plane P may be symmetrically aligned with respect to the rear handle 106 in the substantially lateral direction. However, in various other embodiments of the present invention, the battery 114 may contain the mid-plane P of the rear handle 106 in the substantially lateral direction. In still other embodiments of the present invention, the battery 114 may be located sideways (left or right) of the mid-plane P of the rear handle 106 in the substantially lateral direction. Similar to D1, the distance between the centre of gravity 116 and the mid-plane P may be minimized by varying various parameters.

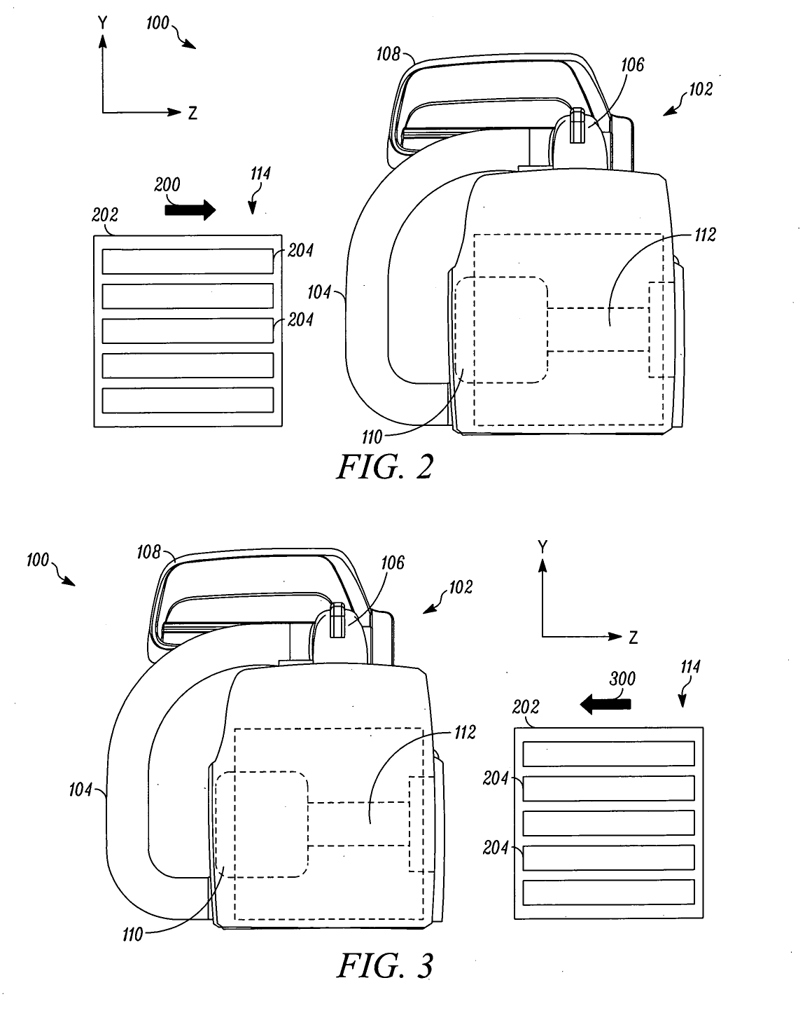

FIG. 2 illustrates a cross-sectional view of the battery 114 in a detached condition, according to an embodiment of the present invention. The battery 114 may include a cell housing 202 which may encase one or more battery cells 204. Though in the example embodiment, the battery cells 204 are shown to be stacked substantially parallel to each other in multiple rows, other configurations (e.g. staggered) may be envisioned without departing from the scope of the present invention. In various embodiments of the present invention, one or more battery cells 204 may also be placed adjacent to one another in the lateral direction of the electric power tool 100. In an embodiment of the present invention, the battery cells 204 may be aligned substantially parallel to the motor shaft 112. However, in other embodiments of the present invention, the battery cells 204 may be obliquely aligned with respect to the motor shaft 112. The one or more battery cells 204 may be rechargeable Lithium-Ion cells. Inner surfaces of the cell housing 202 may include electrical conductors to electrically connect poles of the one or more battery cells 204 to one or more electric contacts (not shown). In an embodiment of the present invention, the one or more electric contacts may engage electrically with one or more corresponding electrical contacts provided in the tool body 102 to form electrical connections. The battery 114 may also include at least one mechanical mating surface (not shown) to mechanically connect the battery 114 to the tool body 102 of the electric power tool 100. The mechanical mating surface may include suitable releasable mechanical connections, such as, but not limited to, snap-fit connections, mating recesses and grooves, connections with resilient members (e.g., springs), or a combination of any of these. The mechanical connections may be selectively locked or released without the use of tools. In other embodiments of the present invention, the mechanical connections may require one or more tools to disassemble the battery 114 from the tool body 102 of the electric power tool 100.

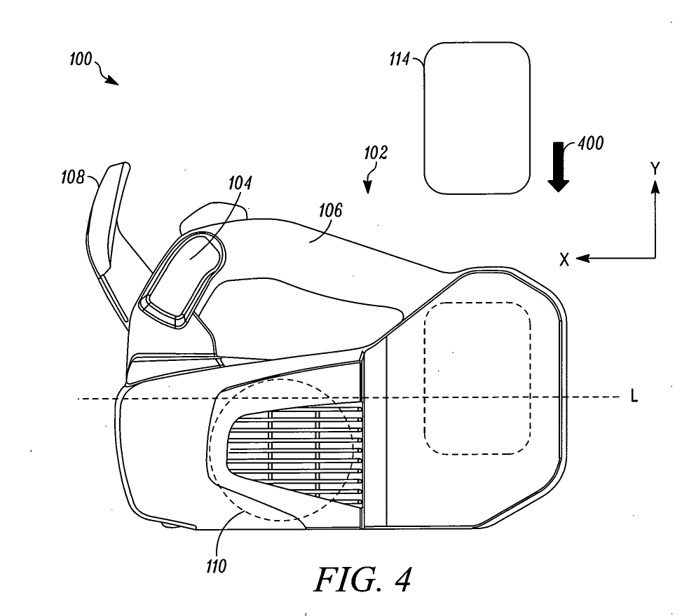

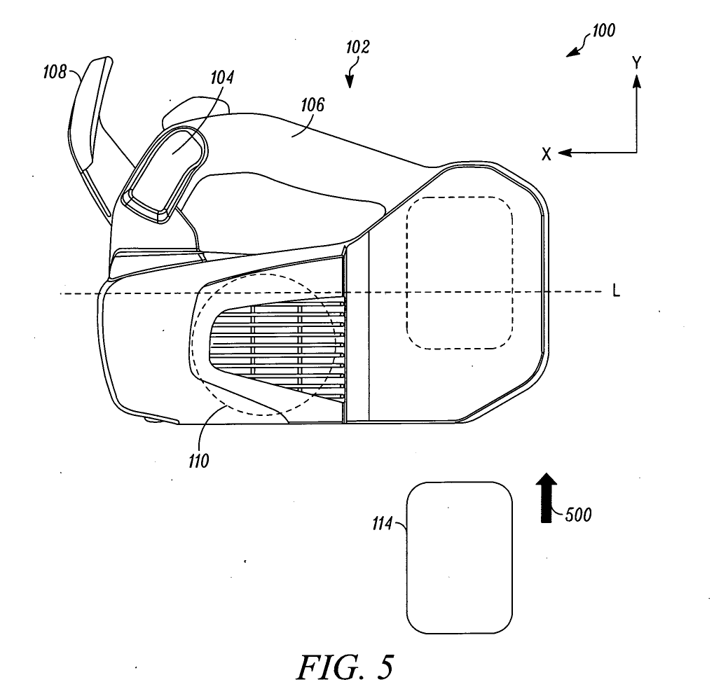

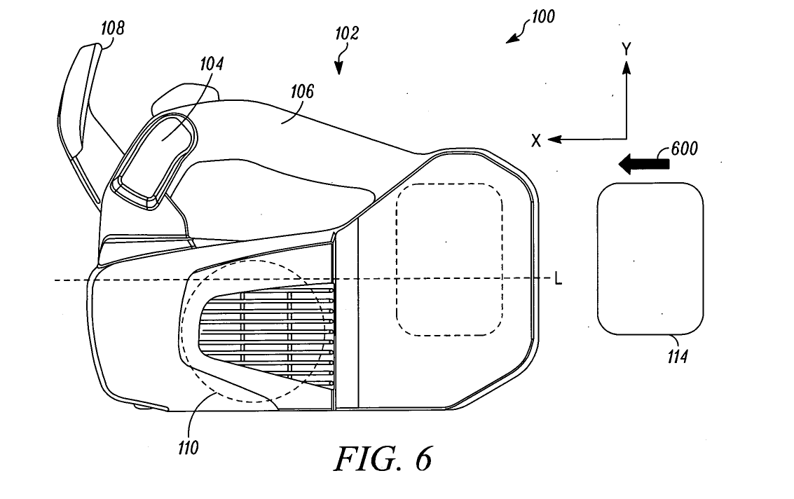

Further, as illustrated in FIGS. 2-6, the battery 114 may be removably attached to the tool body 102 from various directions. For example, as shown by an arrow 200 in FIG. 2, the battery 114 may be removably attached to the tool body 102 substantially from the left. It may be evident that the battery 114 may also be detached in the direction of attachment. In an alternative embodiment of the present invention, as illustrated by an arrow 300 in FIG. 3, the battery 114 may be removably attached to the tool body 102 substantially from the right. In another embodiment of the present invention, as shown by an arrow 400 in FIG. 4, the battery 114 may be removably attached to the tool body 102 substantially from the above. In a still another embodiment of the present invention, as illustrated by an arrow 500 in FIG. 5, the battery 114 may be removably attached to the tool body 102 substantially from the below. In an alternative embodiment of the present invention, as shown by an arrow 600 in FIG. 6, the battery 114 may be removably attached to the tool body 102 substantially from the rear. It is apparent to a person who is ordinarily skilled in the art that the multiple directions shown in FIGS. 2-6 are for illustrative purposes only and the battery 114 may be removably attached to the tool body 102 from any other direction, for example, a substantially oblique direction, without deviating from the scope of the present invention.

FIG. 7 illustrates a chain saw 700 with a rear handle configuration. The chain saw 700 may include a tool body 702 and one or more working implements (not shown). The tool body 702 may include a front handle 704, a rear handle 706 and a guard 708. An electric drive motor 710 may be drivably connected to the working implements. A battery 712 may provide the electrical energy to drive the drive motor 710. As shown in FIG. 7, the battery 712 may be located at least partly in front of the rear handle 706. Further, a centre of gravity 714 of the battery 712 may be located at a distance D1′ from a rear handle axis R′ and a distance D2′ from a motor axis M′ in a substantially vertical direction. The rear handle axis R′ and the motor axis M′ may be symmetrically aligned with respect to the rear handle 706 and the electric drive motor 710 respectively in a substantially vertical direction. In an embodiment of the present invention, D1′ may be such that the centre of gravity 714 of the battery 712 may be located proximate to the rear handle 706 in a vertical direction. In a further embodiment of the present invention, D1′ may be minimized by varying various parameters.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. An electric power tool comprising:
a tool body;
one or more working implements coupled to the tool body;
an electric drive motor drivably connected to the one or more working implements,
at least one battery for supplying the electric drive motor with electrical energy,
wherein the battery comprises at least one battery cell;
a front handle and a rear handle,
wherein the front handle is located at least partly in front of the rear handle along a longitudinal axis; and
wherein an overall center of gravity of the electric power tool is located proximate to the rear handle in a vertical direction.

2. An electric power tool according to claim 1, wherein a center of gravity of the battery is provided proximate to the rear handle in the vertical direction to locate the overall center of gravity of the electric power tool proximate to the rear handle in the vertical direction.

3. An electric power tool according to claim 2, wherein center of gravity of the battery is located on a mid-plane P of the rear handle in a substantially lateral direction.

4. An electric power tool according to claim 2, the battery contains the mid-plane P of the rear handle in the substantially lateral direction.

5. An electric power tool according to claim 2, wherein the battery is located sideways of the mid-plane P of the rear handle in the substantially lateral direction.

6. An electric power tool according to claim 1, wherein the battery is located at least partly behind the rear handle along the longitudinal axis.

7. An electric power tool according to claim 1, wherein the battery is located at least partly in front of the rear handle along the longitudinal axis.

8. An electric power tool according to claim 1, wherein the battery is located at least partly behind the electric drive motor along the longitudinal axis.

9. An electric power tool according to claim 1, wherein the battery is removably attached to the tool body substantially from left.

10. An electric power tool according to claim 1, wherein the battery is removably attached to the tool body substantially from right.

11. An electric power tool according to claim 1, wherein the battery is removably attached to the tool body substantially from above.

12. An electric power tool according to claim 1, wherein the battery is removably attached to the tool body substantially from below.

13. An electric power tool according to claim 1, wherein the battery is removably attached to the tool, body substantially from rear.

14. An electric power tool according to claim 1, wherein the at least one battery cell is substantially parallel to a motor shaft.

15. An electric power tool according to claim 1, wherein the electric power tool is one of a chain saw, a hedge trimmer, or a line trimmer.
